(19) United States
(12) Patent Application Publication
(10) Pub. No.: US 2011/0022378 A1
(43) Pub. Date: Jan. 27, 2011

(54) Translation system using phonetic symbol input and method and interface thereof

(75) Inventors: Chaucer Chiu, Taipei (TW); Huchen Xu, Shanghai (CN)

Correspondence Address: BACON & THOMAS, PLLC, 625 SLATERS LANE, FOURTH FLOOR, ALEXANDRIA, VA, 22314-1176, US

(73) Assignee: INVENTEC CORPORATION, Taipei (TW)

(21) Appl. No.: 12/585,816

(22) Filed: Sep. 25, 2009

(30) Foreign Application Priority Data
Jul. 24, 2009 (TW) 098125115

(51) Int. Cl. G06F 17/28

(52) U.S. Cl. 704/3

(57) ABSTRACT

This specification provided a translation system using phonetic symbol input and the method and interface thereof. The entered phonetic symbols are used as input information. The input information is compared with the translational explanation in the translation database. When there is a match in the comparison, the corresponding word is loaded and displayed for the user to select. After the word selection, the corresponding translational explanation is loaded and displayed. This increases the convenience in translation.

### BACKGROUND OF THE INVENTION

1. Field of Invention

The invention relates to a translation system, method, and interface thereof. In particular, the invention relates to a translation system that uses input phonetic symbols to look for words. The invention also discloses the method and interface thereof.

2. Related Art

In recent years, with the popularity of computers and development in Internet technology, people encounter more often non-native languages than before. For an ordinary user, there are many difficulties in comprehending another language. This leads to the invention of translation software that translates a non-native language to the native language.

Generally speaking, the translation software can look for a word in the non-native language entered by the user and find its explanation in the native language. However, if the word is not presented in a written form to the user, he cannot know exactly how to spell the word. In this case, the user cannot use the usual translation software for translation. For example, suppose the user only know the pronunciation of the word “moon” in a non-native language. Since he does not know how to spell it and it is impossible to enter its phonetic symbols to search, the user cannot use the above-mentioned translation software for translation.

In view of this, some companies propose to employ a speech input method for the translation. This method then uses a speech-to-text (STT) speech conversion engine to convert the speech into text. It then translates the converted text. However, not everyone has the same pronunciation for the same word. Thus, the converted word may not be the exact one. This is troublesome. Also, this method does not allow the user to enter phonetic symbols for translation.

In summary, the prior art always has the problem that one cannot use phonetic symbols for translation. It is thus imperative to provide a solution.

### SUMMARY OF THE INVENTION

In view of the foregoing problem, the invention discloses translation system, method and interface that allow phonetic input.

The disclosed translation system using phonetic symbol input includes: a translation database, an input module, a comparing module, and a displaying module. The translation database stores translation words, each of which has a corresponding translational explanation. The input module is used to enter an input message. The input message includes at least one phonetic symbol. The comparing module compares the input message with the translational explanation corresponding to each of the translation words according to some comparison rules. When there is a match in the comparison, the corresponding translation word is loaded. The displaying module displays the loaded translation words for the user to select. After the word selection, the selected translation word and the corresponding translational explanation are loaded and displayed.

The disclosed translation method using phonetic symbol input includes the steps of: establishing translation words in a translation database, each of the translation words having a corresponding translational explanation; entering an input message that includes at least one phonetic symbol; according to some comparison rule, comparing the input message with the translational explanation corresponding to each of the translation words and, when there is a match, loading the matched translation word from the translation database; displaying the loaded translation words for the user to select and, after the word selection, loading and displaying the selected translation word and the corresponding translation explanation.

The disclosed translation interface using phonetic symbol input includes: phonetic symbol keys, a phonetic symbol input field, a word attribute input field, and an explanation input field. The phonetic symbol keys are displayed in a displaying field. Each of the phonetic symbol keys corresponds to a phonetic symbol. The phonetic symbol input field receives and displays the phonetic symbols produced by clicking the phonetic symbol keys. The word attribute input field receives the displays the input attribute. The explanation input field receives and displays the input explanation.

The disclosed system, method and interface differ from the prior art in that the invention uses the input phonetic symbols as the input message. The input message is then compared with the translational explanation in the translation database. When there is a match in the comparison, the translation word is loaded and displayed for the user to select. After the word selection, the translation word and the corresponding translational explanation are loaded and displayed.

Using the above-mentioned technical means, the invention can increase the convenience and efficiency in searching for translations.

### BRIEF DESCRIPTION OF THE DRAWINGS

The invention will become more fully understood from the detailed description given herein below illustration only, and thus is not limitative of the present invention, and wherein:

FIG. 1 is a block diagram of the disclosed translation system using phonetic symbol input;

FIG. 2 is a block diagram of the disclosed translation method using phonetic symbol input;

FIG. 3 is a block diagram of the disclosed translation interface using phonetic symbol input;

FIGS. 4 and 5 are schematic view of the first embodiment that performs a translation search according to the invention; and

FIGS. 6 and 7 are schematic view of the second embodiment that performs a translation search according to the invention.

### DETAILED DESCRIPTION OF THE INVENTION

The present invention will be apparent from the following detailed description, which proceeds with reference to the accompanying drawings, wherein the same references relate to the same elements.

Before describing the disclosed system, method and interface using phonetic symbol input, we define the terms used herein first. The translation word referred herein is a word in a non-native language for the user (e.g., “moon”). Each translation word has a corresponding translation explanation that includes at least phonetic symbols, attribute, and explanation. Take the translation word “moon” as an example. Its translational explanation includes the phonetic symbols “[mun]”, the attribute “n.” and the translational explanation.

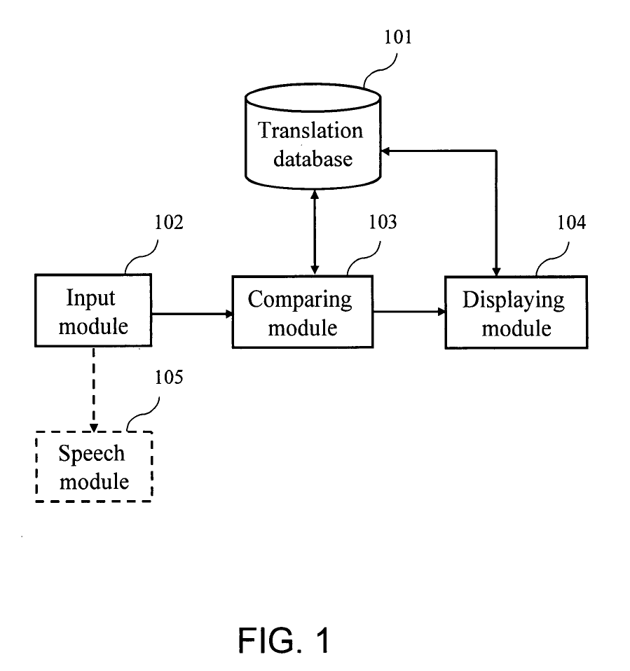

In the following paragraphs, please refer to the accompanying figures for the description of the invention. Please first refer to FIG. 1, which is a block diagram of the disclosed translation system using phonetic symbol input. The system includes: a translation database 101, an input module 102, a comparing module 103, and a displaying module 104. The translation database 101 stores translation words, each of which has a corresponding translational explanation. The translation database 101 in practice can be a relational database or a text file. The terms “translation word” and “translational explanation” have been defined before. They are not further described hereinafter.

The input module 102 is designed for the user to enter an input message which includes at least one phonetic symbol. The phonetic symbols may belong to the KK system or the DJ system. In practice, the input module 102 can be an input interface with phonetic symbol keys for the user to enter. The input interface can be displayed or hidden by pressing a functional key or clicking. The detailed implementation method will be described later. It should be noted that in addition to the phonetic symbols, the input message can further include at least the attribute or explanation. The input attribute and the input explanation can be entered via the above-mentioned input interface as well.

The comparing module 103 compares the input message with the translational explanation of each of the translation words according to some comparison rule. When there is a match in the comparison, the corresponding translation word is loaded from the translation database 101. The comparison rule includes the setting of whether any difference in long and short sounds and similar sounds is allowed. The system compares each of the phonetic symbols. For example, suppose the comparison rule allows the difference in long and short sounds and similar sounds. If the input message is “[pik]”, then the comparing module 103 compares this input message with the phonetic symbols recorded in the translational explanation of each of the translation words. Since the comparison rule in this example allows differences in long and short sounds and similar sounds, long and short sounds are considered as the same and similar sounds the same as well. For example, the long sound “i” and the short sound “I” are considered the same. Besides, the sound “k” and the sound “g” are similar and thus considered the same. Therefore, the comparing module 103 uses the input message “[pik]” to find for both “[pik]” and “[pIg]”. Both the translation words “peek” and “pig” are then loaded.

The displaying module 104 displays all of the loaded translation words for the user to select. After some word is selected, the system loads from the translation database 101 the selected translation word and the corresponding translation explanation. In the above example, both translation words “peek” and “pig” are loaded. The displaying module 104 therefore displays both of them for the user to select. After the user selects one of them (e.g., “pig”), then the system loads from the translation database 101 the translation word (e.g., “pig”) and the corresponding translational explanation (e.g., “[pIg]; n.; . . . ”). In practice, the search result can be presented in the fashion of a pull-down menu.

Besides, the disclosed translation system using phonetic symbol input can further include a speech module 105 that uses a text-to-speech (TTS) speech engine to convert the input message into a speech message and plays it. The speech engine is used to convert the input phonetic symbols into speech. This part belongs to the prior art and is not further explained.

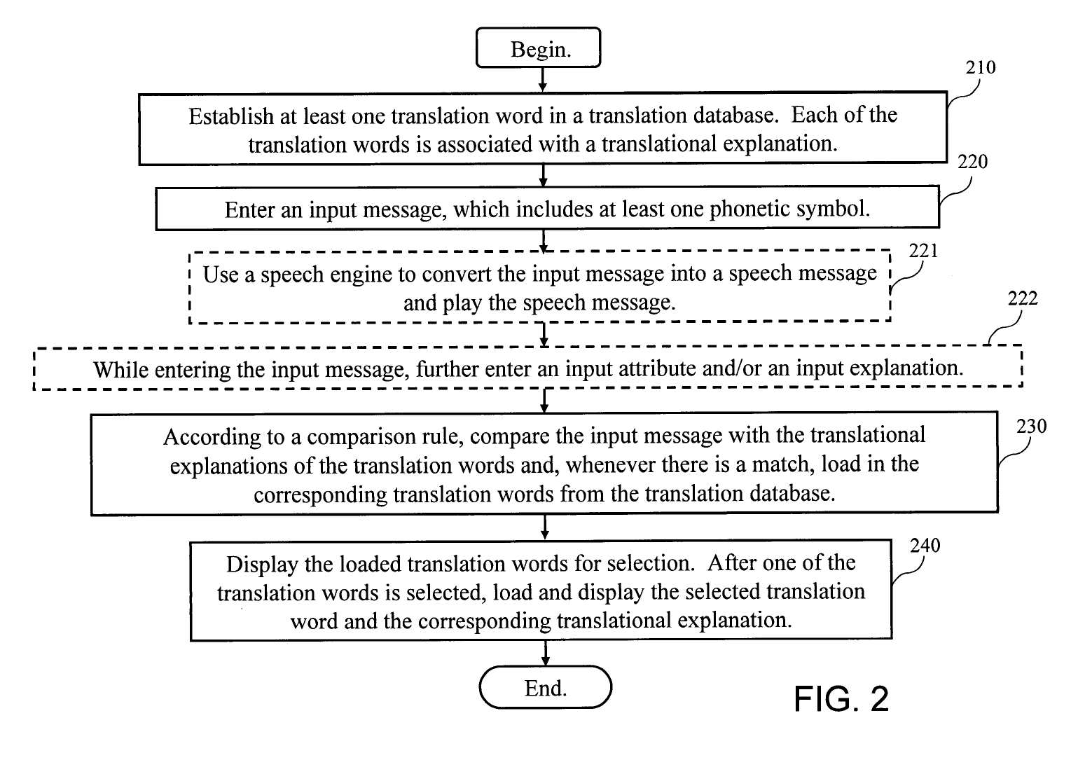

FIG. 2 is a flowchart of the disclosed translation method using phonetic symbol input. The method includes the steps of: establishing translation words in a translation database 101, each of the translation words having a corresponding translational explanation (step 210); entering an input message that includes at least one phonetic symbol (step 220); according to some comparison rule, comparing the input message with the translational explanation corresponding to each of the translation words and, when there is a match, loading the matched translation word from the translation database (step 230); displaying the loaded translation words for the user to select and, after the word selection, loading and displaying the selected translation word and the corresponding translation explanation (step 240). Through the above-mentioned steps, the entered phonetic symbols are taken as the input message. The input message is compared with the translational explanations in the translation database 101. Whenever a match is found, the corresponding translation word is loaded from the translation database 101 for the user to select. After the word selection, the translation word and the corresponding translational explanation are loaded from the translation database 101. Therefore, the user can use phonetic symbol input to search for words.

Moreover, after step 220, one may insert the steps of: converting the input message into a speech message and playing it using a speech engine (step 221); and while entering the input message, further entering at least an input attribute or an input explanation (step 222). Through the above steps, the user can judge whether the entered phonetic symbols are correct from the played speech message. He can also include the attribute and the explanation as additional searching criteria.

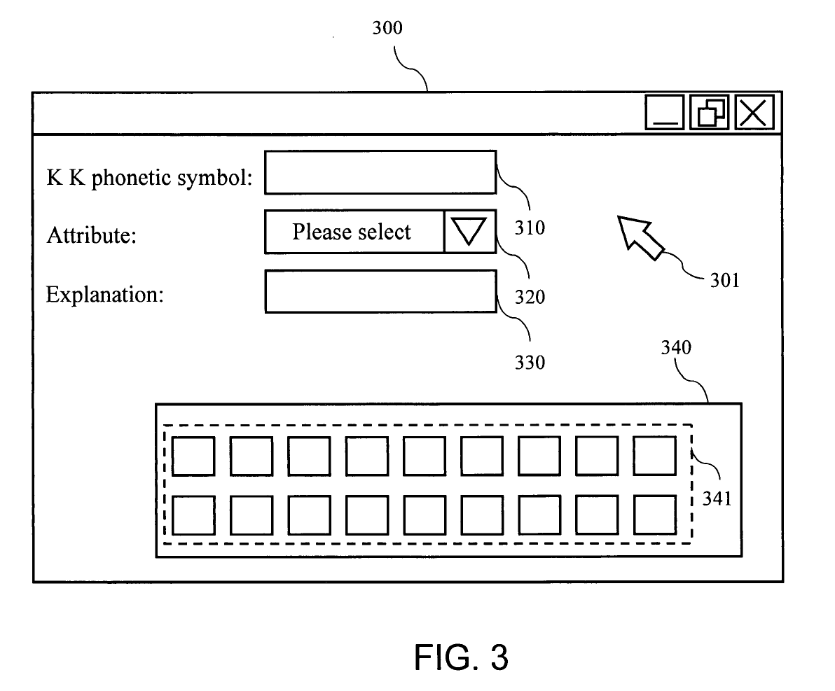

FIG. 3 is a schematic view of the disclosed translation interface using phonetic symbol input. It includes: an input interface 300, a cursor 301, a phonetic symbol input field 310, an attribute input field 320, an explanation input field 330, a displaying field 340, and phonetic symbol keys 341. The input interface 300 is a graphics user interface (GUI) that enables the user to enter information. In practice, the user can use the cursor 301 and/or press functional keys to manipulate.

The phonetic symbol input field 310 receives and displays the phonetic symbols produced by pressing the phonetic symbol keys 341. The phonetic symbol keys 341 are displayed in the displaying field 340. Each of the phonetic symbol keys 341 corresponds to one phonetic symbol. In practice, the user enters phonetic symbols by pressing these phonetic symbol keys 341. Moreover, the displaying field 340 can be dragged by the cursor 301 to any position on the screen. The user can press a functional key or cursor-click to display or hide the displaying field 340 and the phonetic symbol keys 341.

The attribute input field 320 receives and displays an input attribute. In practice, the attribute input field 320 can show all sorts of attributes (e.g., noun, verb, adjective, etc) using a pull-down menu. The user selects one of them as the input attribute, which is then written into the input message.

The explanation input field 330 receives and displays an input explanation. In practice, the user enters text in the explanation input field. The text is then written into the input message as the input explanation.

It should be particularly mentioned that the elements and the corresponding numbers in the input interface 300 are not restricted by the invention. For example, suppose the phonetic symbol input field 310 receives KK phonetic symbols. Then the input interface 300 may further have another phonetic symbol input field (not shown) for the input of DJ phonetic symbols. Or there can be a playing element (not shown). After the user clicks the playing element, the input message is converted by a speech engine into speech and played. The additional phonetic symbol input field and the playing element will be further described later.

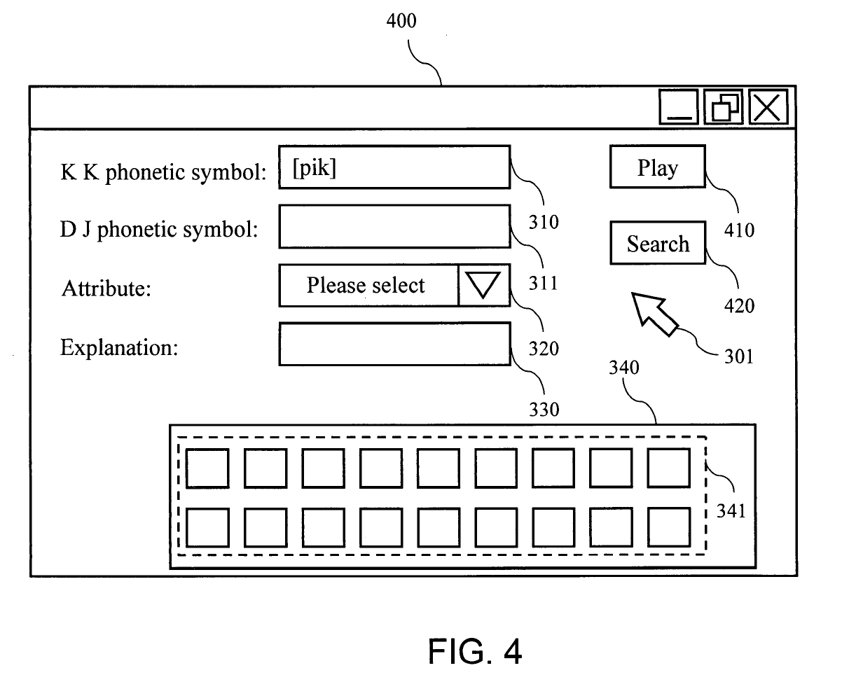

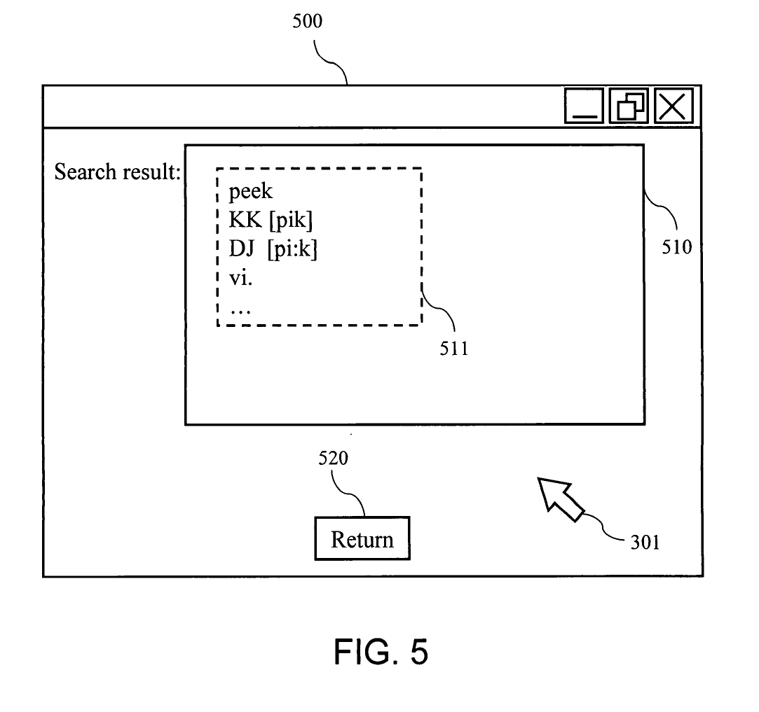

With reference to FIGS. 4 to 7, an embodiment is used to explain the invention in the following paragraphs. FIGS. 4 and 5 are schematic view of the first embodiment that performs translation searching according to the invention. As shown in FIG. 4, the interface includes: an input interface 400, a cursor 301, a phonetic input field 310, a secondary phonetic symbol input field 311, an attribute input field 320, an explanation input field 330, a displaying field 340, phonetic symbol keys 341, a playing element 410, and a searching element 420. When a user only knows the pronunciation of the word “peek” in a non-native language, he can enter the corresponding KK phonetic symbols “[pik]” via the input interface 400 to search for it. The user first uses the cursor 301 to click the phonetic symbol input field 310, and then clicks in sequence the phonetic symbols 341 “p”, “i”, and “k” in the displaying field 340. After finishing the input, the user uses the cursor 301 to click the searching element 420 for translation searches. In this case, the input module 102 takes the entered phonetic symbols “[pik]” in the phonetic symbol input field 310 as the input message. It should be noted that the user can display or hide the displaying field 340 and the phonetic symbol keys 341 by pressing a functional key or cursor-clicking, or he can drag the displaying field 340 by cursor 301 to change the position of the displaying field 340 and the phonetic symbol keys 341. For example, the system can define in advance is functional key, such as the “F1” key on a keyboard. When the user presses this functional key, the displaying field 340 and the phonetic symbol keys 341 (the so-called software keyboard) are displayed. The user can further use the cursor 301 to drag the displaying field 340 and the phonetic symbol keys 341 to change their position. In other words, the displaying position is floating (i.e., changeable) instead of being fixed. When the user presses this functional key (“F1”) again, the displaying field 340 and the phonetic symbol keys 341 are hidden.

Afterwards, the comparing module 103 uses a predetermined comparison rule to compare the input message with the translational explanations associated with all of the translation words in the translation database 101. Whenever there is a match, the corresponding translation word is loaded from the translation database 101. Following the above-mentioned example, suppose now the comparison rule is that no difference in long and short sounds and similar sounds is allowed. The comparing method is to compare the input message “[pik]” with the phonetic symbol information recorded in the translation explanations. It looks for completely the same phonetic symbols “[pik]”. After a complete match is found, the system loads in the corresponding translation word “peek” from the translation database 101. Suppose the predetermined comparison rule allows differences in long and short sounds and similar sounds. When the input message “[pik]” is compared with the phonetic symbol information recorded in the translation explanations, the long sounds and shorts sounds are considered the same phonetic symbol. For example, the long-sound phonetic symbol “i” is considered the same as the short-sound phonetic symbol “I”. Moreover, the similar sounds (sounds with similar pronunciations) are considered the same. For example, the phonetic symbol “k” is considered the same as the phonetic symbol “g”. Following this scheme, the comparison is done for “[pik]”, “[pIg]”, and so on. In the end, the corresponding translation words such as “peek”, “pig”, and so on are loaded from the translation database 101.

Afterwards, the displaying module 104 displays the loaded translation words for the use to select. After the user selects one of the translation words loaded by the comparing module 103, the displaying module 104 loads the selected translation word and the corresponding translational explanation from the translation database 101 and displays them. For example, suppose the comparison rule of the comparing module 103 is no difference in long and short sounds and similar sounds is allowed and the loaded word is “peek”. Since under the comparison rule, there is only one matched translation word, the system thus directly opens a search result window 500 as shown in FIG. 5. The translation word “peek” and the corresponding translational explanation are used as the searching result 511. They are displayed in the result display field 510. If the user wants to perform another translation search, he can use the cursor 301 to click the returning element 520 and go back to the above-mentioned input interface 400.

It should particularly mentioned that in practice, the input interface 400 can set the phonetic input field 310 for the KK phonetic symbols and the secondary phonetic input field 311 for the DJ phonetic symbols. The user can opt to enter KK phonetic symbols in the phonetic symbol input field 310 or DJ phonetic symbols in the secondary phonetic symbol input field 311 to generate an input message. Moreover, if the user also knows the attribute of the non-native-language word, he can enter the information in the attribute input field 320 (e.g., selecting “noun” using the pull-down menu). Alternatively, if the user knows the rough meaning of the non-native-language word, he can enter corresponding text in the explanation input field 330. In this case, the input module 102 further uses the attribute selected in the attribute input field 320 and the text entered in the explanation input field 330 as the input attribute and the input explanation, respectively. They are then written into the input message. In this case, the input message includes the phonetic symbols, the input attribute and the input explanation.

Following the above description, suppose the translational explanation includes phonetic symbol message, attribute message, and explanation message. When the comparing module 103 compares the input message with the translation explanations of all translation words in the translation database 101, the comparison is also done between the input attribute (e.g., “noun”) and the attribute message (e.g., “noun”, “n.” or “n.”) and between the input explanation and the explanation message. As long as the explanation message includes the input explanation, then the system considers it as a match. When all the three criteria are satisfied, the corresponding translational explanation is loaded from the translation database 101. This can effectively minimize the searching range. In addition, the user can use the cursor 301 to click a playing element 410, which uses a TTS speech engine to convert the text input message into a speech message and plays it with a speaker (not shown).

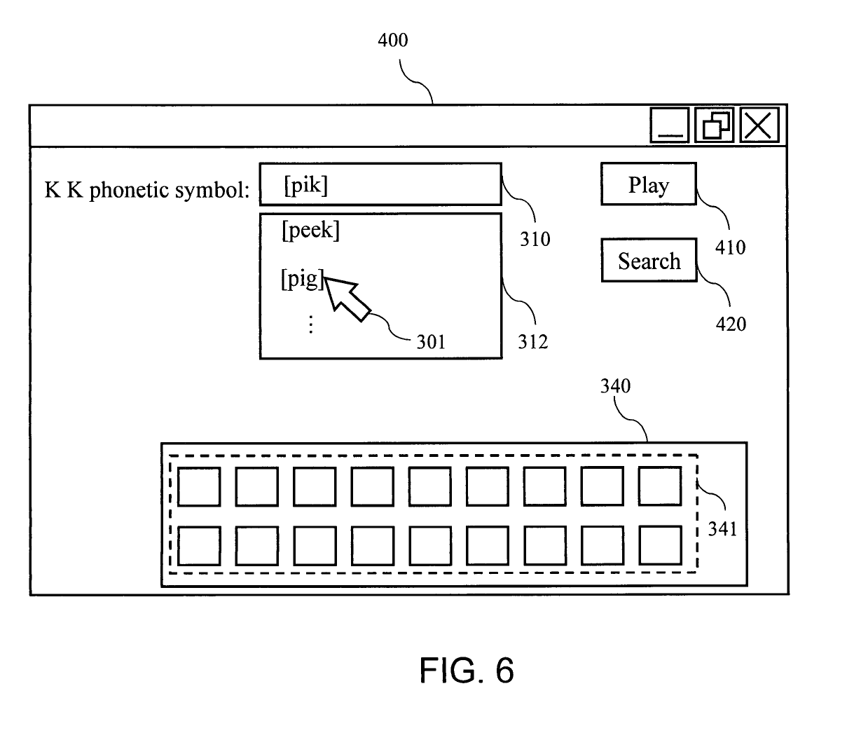

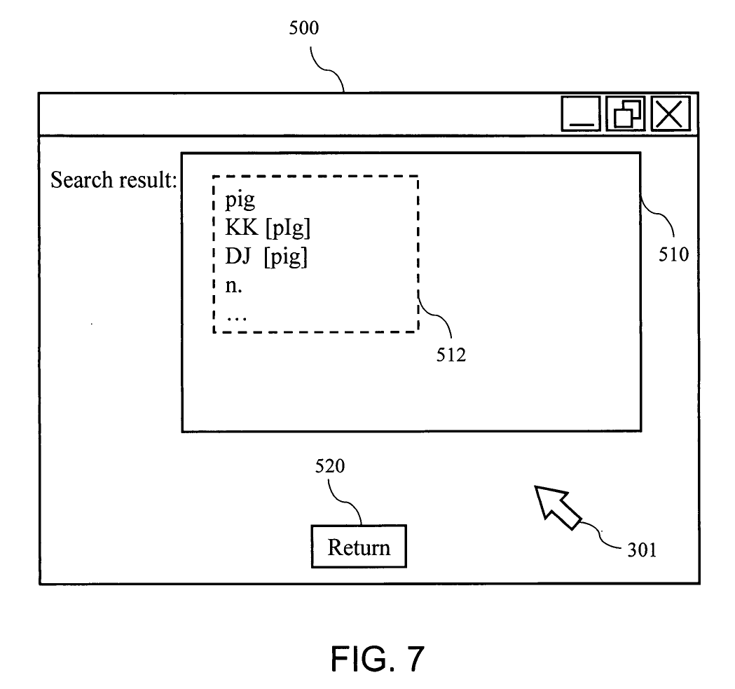

FIGS. 6 and 7 show the second embodiment of the invention. As mentioned before, when the comparison rule allows differences in long and short sounds and similar sounds, the comparing module 103 loads in all corresponding translation words from the translation database 101. Take the above-mentioned input message “[pik]” as an example. Since differences in long and short sounds and similar sounds are allowed, the phonetic messages “[pIg]” and “[pik]” are considered as the same in the comparing process. This is because the short-sound phonetic symbol “I” and the long-sound phonetic symbol “i” are considered the same, and the phonetic symbols “g” and “k” have similar pronunciations and are thus considered the same as well. Therefore, the comparing module 103 uses the phonetic messages “[pik]”, “[pIg]”, etc to look for the corresponding translation words “peek”, “pig”, etc in the translation database 101. The displaying module 104 displays all the loaded translation words in the pull-down menu 312 shown in FIG. 6 for the user to select one of them. After the user selects one of them, the displaying module 104 loads in the selected translation word and the corresponding translational explanation. A search result window 500 as shown in FIG. 7 is opened for displaying the translation word and the corresponding translation explanation as the search result 512. In other words, the second embodiment only differs from the first embodiment in that the comparison rules are different (whether differences in long and short sounds and similar sounds are allowed). The rest steps are the same as in the first embodiment. Therefore, they are not further described here.

In summary, the invention differs from the prior art in that the input phonetic symbols are used as the input message. The input message is compared with the translational explanations stored in the translation database 101. Whenever there is a match, the corresponding translation word is loaded and displayed for the user to select. After the word selection, the translation word and the corresponding translational explanation are loaded from the translation database 101 and displayed. Using such a technique, the invention enables the phonetic symbol input to solve problems in the prior art. This can effectively increase the convenience and efficiency of translation searches.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A translation system using phonetic symbol input, comprising:
a translation database, which stores a plurality of translation words, each of which is associated with a translation explanation;
an input module, which receives an input message that include at least one phonetic symbol;
a comparing module, which follows a comparison rule to compare the input message with the translational explanations of the translation words and, whenever there is a match, loads the corresponding translation word; and
a displaying module, which displays the loaded translation words for selection and, after selecting one of the translation words, loads and displays the selected translation word and the corresponding translational explanation.

2. The translation system using phonetic symbol input of claim 1, wherein the at least one phonetic symbol is entered via an input interface having a plurality of phonetic symbol key, each of which corresponds to one phonetic symbol.

3. The translation system using phonetic symbol input of claim 1 further comprising a speech module, which uses a speech engine to convert the input message into a speech message and plays the speech message.

4. The translation system using phonetic symbol input of claim 1, wherein the translational explanation includes at least: a phonetic message, an attribute message, and an explanation message and the input message further includes an input attribute and/or an input explanation.

5. The translation system using phonetic symbol input of claim 1, wherein the comparison rule includes the setting of whether any difference in the long and short sounds and similar sounds is allowed.

6. The translation system using phonetic symbol input of claim 6, wherein the input interface is displayed or hidden by pressing a functional key or cursor-clicking.

7. A translation method using phonetic symbol input, comprising the steps of:
establishing in a translation database a plurality of translation words, each of which is associated with a translation explanation;
entering an input message that includes at least one phonetic symbol;
according to a comparison rule, comparing the input message with the translational explanations of all the translation words and, whenever there is a match, loading the corresponding translation word from the translation database; and
displaying the loaded translation words for selection and, after selecting one of the translation words, loading and displaying the selected translation word and the corresponding translational explanation.

8. The translation method using phonetic symbol input of claim 7, wherein the at least one phonetic symbol is entered via an input interface having a plurality of phonetic symbol key, each of which corresponds to one phonetic symbol.

9. The translation method using phonetic symbol input of claim 7 further comprising the step of using a speech engine to convert the input message into a speech message and playing the speech message.

10. The translation method using phonetic symbol input of claim 7, wherein the translational explanation includes at least: a phonetic message, an attribute message, and an explanation message and the input message further includes an input attribute and/or an input explanation.

11. The translation method using phonetic symbol input of claim 7, wherein the comparison rule includes the setting of whether any difference in the long and short sounds and similar sounds is allowed.

12. The translation method using phonetic symbol input of claim 8, wherein the input interface is displayed or hidden by pressing a functional key or cursor-clicking.

13. A translation interface using phonetic symbol input, comprising:
a plurality of phonetic symbol keys displayed in a displaying field, each of which corresponds to one phonetic symbol;
a phonetic symbol input field, which receives and displays the phonetic symbols produced by clicking the phonetic symbol keys;
an attribute input field, which receives and displays an input attribute; and
an explanation input field, which receives and displays an input explanation.

14. The translation interface using phonetic symbol input of claim 13, wherein when some of the phonetic symbol keys are pressed the corresponding phonetic symbols form an input message.

15. The translation interface using phonetic symbol input of claim 13, wherein the displaying position of the displaying field is changed by cursor-dragging.

16. The translation interface using phonetic symbol input of claim 13, wherein the displaying field and the phonetic symbols are displayed or hidden by pressing a functional key or cursor-clicking.
